(19) United States
(12) Patent Application Publication
(10) Pub. No.: US 2023/0011285 A1
(43) Pub. Date: Jan. 12, 2023

(54) BATTERY

(71) Applicant: Mahle International GmbH, Stuttgart (DE)

(72) Inventors: Julius Aktas, Bietigheim-Bissingen (DE); Ursula Steeb, Frickenhausen (DE); Georg Votteler, Backnang (DE); Johannes Weinmann, Stuttgart (DE)

(21) Appl. No.: 17/860,100

(22) Filed: Jul. 8, 2022

(30) Foreign Application Priority Data
Jul. 8, 2021 (DE) 102021207235.6

(51) Int. Cl. H01M 50/569; H01M 50/284

(52) U.S. Cl. CPC H01M 50/569; H01M 50/284; H01M 2220/20

(57) ABSTRACT

A battery may include at least two battery cells and at least two electrical cell contacts for picking up a monitoring signal. The battery may include a main board arranged spaced apart from the battery cells. The main board may include at least two electrical board contacts. The main board may include at least one electronic component configured to process the monitoring signal. The battery may include a flexible conductor track for electrically connecting each cell contact with an associated board contact. The conductor track may include (i) a cell portion connected to the cell contacts and (ii) a board portion connected to the board contacts. The conductor track may include at least two electrical conductors connected to one of the cell contacts and the associated board contact. The battery may include a support plate supporting the board portion of the main board.

### CROSS-REFERENCE TO RELATED APPLICATIONS

This application claims priority to German Pat. Application No. DE 10 2021 207 235.6, filed on Jul. 08, 2021, the contents of which is hereby incorporated by reference in its entirety.

### TECHNICAL FIELD

The present invention relates to a battery, in particular for a motor vehicle, which includes a housing and battery cells received in the housing, each of which comprises an electrical cell contact for picking up a monitoring signal.

### BACKGROUND

As rechargeable electric energy source, a battery serves for electrically supplying a multiplicity of possible applications. In a motor vehicle the battery can serve for example for driving the motor vehicle. Such batteries generally comprise multiple battery cells which are arranged next to one another. Generally, the battery cells are received in a housing of the battery. In order to monitor the electrical supply by means of the battery and/or monitor the state of the battery, a monitoring of the battery cells is generally provided. Here, a signal, in the following also referred to as monitoring signal, is picked up from an electrical contact of the battery cells and evaluated by means of an evaluation unit. The evaluation unit generally includes a main board and components for evaluating the monitoring signal picked up from the battery. This requires an electrical connection between the cell contacts and the main board. Such an electrical connection can be realised more easily and flexibly by a flexible conductor track which is electrically connected to the cell contacts and the main board.

A stable electrical connection between the flexible conductor track and the main board can be achieved by way of wire-bonding. For this purpose, high mechanical forces which act on the conductor track and the main board are necessary for producing the respective wire-bond. Since these forces can lead to the flexible conductor track being damaged, the conductor track is usually supported on the main board by means of a support plate, on which it is supported. In order to avoid relative movements between the support plate and the main board the support plate is generally fastened to the main board. In addition, the flexible conductor track is fastened to the support plate. In order to fix the structure consisting of main board, support plate and flexible conductor track in the battery, the main board, further, is fixed to the housing by means of a connection which is again separate. This leads to a complex production of the battery.

### SUMMARY

The present invention therefore deals with the object of stating for a battery of the type mentioned at the outset an improved or at least another embodiment which is characterised in particular by a simplified production and assembly.

According to the invention, this object is solved through the subject of the independent claim(s). Advantageous embodiments are subject of the dependent claim(s).

The present invention is based on the general idea of electrically connecting to the main board in a battery a flexible conductor track for electrically connecting electrical contacts of battery cells to a main board for evaluating signals originating from the battery cells, in the following also referred to as monitoring signals, by means of wire-bonds and providing a support plate between the flexible conductor track and the main board, wherein a common connection mechanically fastens the conductor track to the support plate, the support plate to the main board and the structure consisting of main board, support plate and flexible conductor track to a holder within the battery. Thus, in particular separate connections each for fixing the conductor track to the support plate, for fastening the support plate to the main board and for fastening the structure to the holder can be omitted. This leads to a substantial simplification of the assembly and the production of the battery.

According to the inventive idea, the battery includes the battery cells which are consecutively arranged. The respective battery cell comprises an electrical cell contact for picking up a monitoring signal. The main board is arranged spaced apart from the battery cells, in particular from the cell contacts and comprises for at least two of the cell contacts an associated electrical contact each, which in the following is also referred to as board contact. The board is provided with at least one electrical component which during the operation processes the monitoring signal originating from at least one cell contact. Further, the battery includes the flexible conductor track by means of which at least two cell contacts are each electrically connected to the associated board contact. The flexible conductor track, also known to the person skilled in the art as flexible printed circuit or FPC in brief, comprises a portion connected to the cell contacts which in the following is also referred to as cell portion, and a portion connected to the main board, in the following also referred to as board portion. The flexible conductor track practically comprises for the respective cell contact and the associated board contact an associated electrical conductor which in the cell portion is electrically connected to the associated cell contact and in the board portion to the associated board contact. The electrical connection of at least one of the conductors, advantageously of the respective conductor to the associated board contact is effected by means of wire-bonds. Here, a support plate is arranged between the board portion of the conductor track and the main board on which the board portion is supported and mechanically stabilised. According to the invention, at least one common mechanical connection fastens the board portion, the support plate and the main board to the holder.

Practically, the flexible conductor track, besides the electrical conductors, comprises a flexible carrier which is practically electrically insulating.

Practically, the holder is fixed within the battery, in particular relative to the battery cells, in particular on the battery cells.

Practically, the battery comprises a housing in which the battery cells, preferentially in addition the flexible conductor track and/or the main board, are received.

The battery cell can be of any type.

In particular, at least one of the battery cells, advantageously the respective battery cell, can be a round cell or a prismatic cell.

Preferably, at least two of the battery cells, in particular all battery cells are formed identically.

The main board and the at least one component practically form a unit in which at least an evaluation of the picked-up monitoring signals takes place. Practically, the main board and the at least one component are part of a controller also known as cell module controller to the person skilled in the art or CMC in brief.

Basically, the respective wire-bond can be realised in any way. For this purpose, ultrasound and/or laser are/is employed for example. The wire-bond can thus be in particular an ultrasound bond and/or laser bond.

During wire-bonding, a wire bridge, advantageously a sheet metal wire, is electrically connected to the associated board contact and the associated conductor of the flexible conductor track by means of ultrasound and/or laser.

The respective connection for jointly fastening the board portion, the support plate and the main board to one another and to the holder can basically be configured in any way.

Preferably, at least one of the connections, advantageously the respective connection, is a screw connection. This means that a common screw connection fastens the board portion, the support plate and the main board to one another and to the holder. This leads to a particularly simple and mechanically stable fastening. For this purpose, the board portion, the support plate and the main board comprise screw openings aligned with one another, through which a screw is passed and screwed to the holder. In the process, the screw preloads the board portion, the support plate and the main board against one another and against the holder.

Advantageously, the cell contacts are arranged on a longitudinal side of the battery whereas the main board is arranged on a transverse side of the battery running transversely to the longitudinal side. Here, the cell portion of the flexible conductor track practically runs along the longitudinal side and the board portion along the transverse side. Further, the conductor track comprises a portion arranged between the cell portion and the board portion, which in the following is also referred to as bending portion. The bending portion connects the cell portion to the board portion and abuts between the longitudinal side and the transverse side. Thus, a simple and insulation space-saving design of the battery is achieved.

Embodiments, in which the main board on the transverse side delimits with the holder a hollow space for introducing a bonding tool are considered advantageous. Advantageously, the hollow space is laterally open here. This means that the hollow space is open transversely to the spacing direction of the main board to the support plate or the main board to the transverse side. Here, the bonding tool can be easily and effectively introduced laterally into the hollow space between the main board and the holder. This leads to a simple production of the wire-bonds.

It is preferred when the support plate and the board portion are arranged on the side of the main board facing away from the holder. This means that the main board is preferably next adjacent to the holder. Thus, the electrical connection between the board portion and the main board can be produced by means of the wire-bonds in a simplified manner and an increased mechanical stability achieved at the same time.

Basically, the flexible conductor track can comprise a single board portion.

It is also conceivable that the conductor track comprises at least two board portions spaced apart from one another. Here, an associated such common connection is advantageously provided for the respective board portion.

It is preferable when for the respective board portion an associated support plate is provided.

Basically, the holder of the battery can be configured in any way. In particular, the holder can be at least partially produced from plastic. It is also conceivable that the holder is a plastic holder.

It is to be understood that the battery can also comprise two or more such flexible conductor tracks. Here, a common connection of the type described above and to be explained in the following is advantageously provided for the respective board portion of the respective conductor track.

The battery can be basically employed in any application.

In particular, the battery is employed in a motor vehicle and in the motor vehicle can serve for driving the motor vehicle.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

A preferred exemplary embodiment of the invention is shown in the drawings and is explained in more detail in the following description, wherein same reference numbers relate to same or similar or functionally same components.

### BRIEF DESCRIPTION OF THE DRAWINGS

It shows, in each case schematically

FIG. 1 shows a front view of a battery,

FIG. 2 shows an isometric part view of the battery,

FIG. 3 shows a section through the battery in the region of a main board.

### DETAILED DESCRIPTION

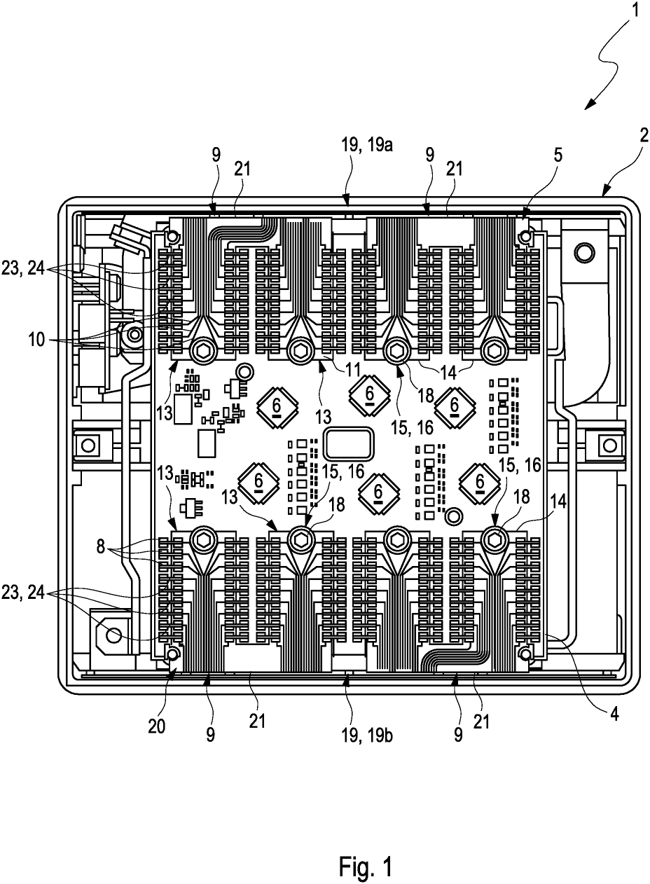

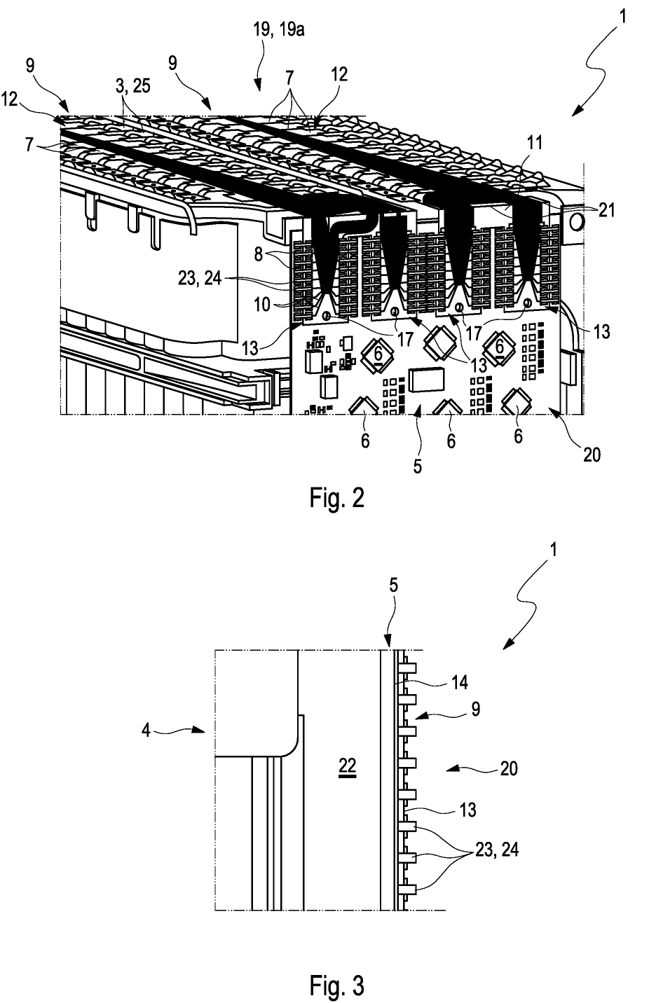

A battery 1, as is shown in the FIGS. 1 to 3, comprises a housing 2, in which multiple battery cells 3 merely visible in FIG. 2, in particular round cells 25, are received. The battery 1 can be employed for example in a motor vehicle which is not otherwise shown and serve for driving the motor vehicle. The housing 2 is at least partially, in particular entirely, produced from plastic. The battery cells 3 are consecutively arranged in the housing 2. For monitoring the battery cells 3, the battery 1 further comprises a main board 5. With the main board 5, signals picked up from the battery cells 3, in the following also referred to as monitoring signals, are processed and in particular evaluated. For this purpose, at least one electronic component 6 for processing the monitoring signals is provided on the main board 5. For picking-up the monitoring signals, the respective battery cell 3 comprises a corresponding electrical contact 7 which in the following is also referred to as cell contact 7. In addition, the main board 5 comprises for at least two of the cell contacts 7 an associated electrical contact 8 each, which in the following is also referred to as board contact 8. The electrical connection between the cell contacts 7 and the board contacts 8 is produced by means of at least one flexible conductor track 9, also known as flexible printed circuit or FPC in brief to the person skilled in the art. For this purpose, the respective conductor track 9 comprises a respective associated electrically conductive and flexible conductor 10 for connecting associated board contacts 8 and cell contacts 7. In addition, the conductor track 9 comprises for the conductors 10 a flexible and electrically insulating carrier 11. The electrical connection between the respective conductor 10 and the associated board contact 8 is effected by means of wire-bonds. For this purpose, a wire-bridge 23, in particular a sheet metal wire 24, is electrically connected to the associated board contact 8 and an end of the associated conductor 10, in particular by means of ultrasound and/or laser. Further, the respective conductor 10, spaced apart from the board contacts 8, is electrically connected to at least one of the associated cell contacts 7. The respective conductor track 9 thus comprises a portion 12 connected to the associated cell contacts 7, in the following also referred to as cell portion 12, and a portion 13 connected to the main board 5 or the associated board contacts 8, in the following also referred to as board portion 13. Furthermore, between the board portion 13 of the conductor track 9 and the main board 5 an electrically insulating support plate 14 is arranged, on which the board portion 13 is supported and mechanically stabilised. Thus, the support plate 14 serves in particular for the purpose of avoiding or at least reducing the conductor track being damaged and in particular to mechanically stabilise the electrical connection of the conductors 10 to the board contacts 8. In the shown exemplary embodiment an associated support plate 14 is provided for the respective board portion 13. As is evident in particular from FIG. 2, the respective flexible conductor track 9 shown in the shown exemplary embodiment comprises two board portions 13 spaced apart from one another and a common cell portion 12.

A common mechanical connection 15 fastens the respective board portion 13, the associated support plate 14 and the main board 5 to one another and to a holder 4 in the housing 2. In the shown exemplary embodiment, a single common connection 15 each fastens the respective board portion 13, the associated support plate 14 and the main board 5 to one another and to the holder 4. As a consequence, further separate mechanical fastenings of the main board 5, of the support plate 14 and of the respective board portion 13 are not required. The result is a simplified design and production as well as assembly of the battery 1, wherein at the same time there is a high mechanical stabilisation of the electrical connections. Here, the respective support plate 14 and the respective board portion 13 are arranged on the side of the main board 5 facing away from the holder 4.

In the shown exemplary embodiment and preferably the respective connection 15 is realised as a screw connection 16. For establishing the respective screw connection 16, the board portion 13, the support plate 14 and the main board 5 comprise screw openings 17 (see FIG. 2) which are aligned with one another. A screw 18 is passed through the screw openings 17 aligned with one another and screwed to the holder 4, wherein the screw 18 is not shown in FIG. 2. Thus, the board portion 13, the support plate 14 and the main board 5 are pressed and preloaded against one another and against the holder 4 by means of the screw 18.

In the shown exemplary embodiment, the cell contacts 7 and the main board 5 are arranged on sides 19, 20 of the battery 1 in particular of the battery cells 3 that are spaced apart from one another and run transversely to one another. This means that the cell contacts 7 are arranged on a side 19, which in the following is also referred to as longitudinal side 19, and the main board 5 on a side 10 running transversely to the longitudinal side 19, which in the following is also referred to as transverse side 20. Consequently, the cell portion 12 of the respective conductor track 9 runs along the longitudinal side 19 and the respective board portion 13 along the transverse side 20. The cell portion 12 and the at least one board portion 13 of the respective conductor track 9 are connected to one another by a portion 21 arranged between the cell portion 12 and the at least one board portion 13 and interconnecting these, in the following also referred to as bending portion 21. Here, the bending portion 21 abuts on the holder 4 between the longitudinal side 19 and the transverse side 20 and is bent over.

As indicated in FIG. 1, the battery cells 3 comprise, on two longitudinal sides 19 facing away from one another, at least one cell contact 7 each, which are each connected to the main board 5 by means of such a conductor track 9. This means that the battery 1, along a first longitudinal side 19a and a second longitudinal side 19b facing away from the first longitudinal side 19a, comprises cell contacts 7 which by means of associated flexible conductor tracks 9 are electrically connected to the main board 5 in the manner described above.

As is evident from FIG. 3, the main board 5, on its side facing the holder 4, delimits, in the shown exemplary embodiment, jointly with the holder 4, a hollow space 22. This means that the main board 5 on the transverse side 20 with the holder 4 delimits the hollow space 22. The hollow space 22 serves in particular for introducing a bonding tool which is not shown, in order to mechanically support the main board 5, the respective support plate 14 and the respective board portion 13 during the wire-bonding. Advantageously, the hollow space 22 is open laterally, i.e. transversely to the spacing direction of the main board 5 to the support plate 14. Thus, the bonding tool can be easily introduced into the hollow space 22 and removed out of the hollow space 22 without damaging the main board 5, the support plate 14 and the conductor track 9 and the electrical connections.

1. A battery, comprising:
at least two consecutive battery cells and at least two electrical cell contacts for picking up a monitoring signal, each battery cell of the at least two consecutive battery cells including an electrical cell contact of the at least two electrical cell contacts;
a main board arranged spaced apart from the at least two consecutive battery cells, the main board including at least two electrical board contacts;
at least one electronic component mounted on the main board, the at least one electronic component configured to process the monitoring signal originating from at least one cell contact of the at least two cell contacts;
at least one flexible conductor track electrically connecting each of the at least two cell contacts with an associated board contact of the at least two board contacts;
the at least one conductor track including (i) a cell portion connected to the at least two cell contactsand (ii) at least one board portion connected to the main board;
the at least one conductor track including at least two electrical conductors, each electrical conductor of the at least two electrical conductors electrically connected to one of the at least two cell contacts and the associated board contact;
at least one of the at least two electrical conductors connected to the respective board contact via wire-bonds;
a support plate arranged between the at least one board portionand the main board, the support plate supporting the at least one board portion;
a holder; and
at least one mechanical connection fastening the at least one board portion, the support plate, and the main board to one another and to the holder.

2. The battery according to claim 1, wherein:
the at least one mechanical connection is a screw connection;
a screw opening in the at least one board portion, a screw opening in the support plate, and a screw opening in the main board are aligned with one another;
a screw is passed through the screw opening in the at least one board portion, the screw opening in the support plate, and the screw opening in the main board and is screwed to the holder to define the screw connection; and
the screw preloads the at least one board portion, the support plate, and the main board against one another and against the holder.

3. The battery according to claim 1, wherein:
the at least two cell contacts are arranged on a longitudinal side of the at least two consecutive battery cells and the main board is arranged on a transverse side of the at least two consecutive battery cells, the transverse side extending transversely to the longitudinal side;
the cell portion extends along the longitudinal side and the at least one board portion extends along the transverse side; and
the at least one conductor track further includes a bending portion connecting the cell portion and the at least one board portion, the bending portion abutting in a transition region between the longitudinal side and the transverse side.

4. The battery according to claim 3, wherein the main board, on the transverse side, and the holder delimit a hollow space that is laterally open for introducing a bonding tool.

5. The battery according to claim 1, wherein the support plate and the at least one board portion are arranged on a side of the main boardfacing away from the holder.

6. The battery according to claim 1, wherein:
the at least one board portion includes at least two board portions arranged spaced apart from one another; and
the at least one mechanical connection includes at least two mechanical connections, each of the at least two mechanical connections connecting a respective board portion of the at least two board portions, the support plate, and the main board to one another and to the holder.

7. The battery according to claim 1, wherein:
the at least one conductor track includes at least two conductor tracks; and
the at least one mechanical connection includes at least two mechanical connections, each of the at least two mechanical connections connecting the at least one board portion of a respective conductor track of the at least two conductor tracks, the support plate, and the main board to one another and to the holder.

8. The battery according to claim 1, further comprising a wire bridge attached to the at least one of the at least two electrical conductors and the respective board contact, wherein the wire bridge defines the wire-bonds.

9. The battery according to claim 8, wherein the wire bridge is connected to the respective board contact via at least one of an ultrasound bond and a laser bond.

10. The battery according to claim 1, wherein the holder is composed of plastic.

11. A battery, comprising:
a battery cell including an electrical cell contact for picking up a monitoring signal;
a main board arranged spaced apart from the battery cell, the main board including an electrical board contact;
a flexible conductor track for electrically connecting the cell contact and the board contact;
the main board including an electronic component configured to process the monitoring signal picked up by the cell contact;
the conductor track including an electrical conductor connected to the cell contact and the board contact; and
wherein the conductor is connected to the board contact via wire-bonds.

12. The battery of claim 11, wherein the flexible conductor track further includes:
a cell portion connected to the cell contact; and
a board portion connected to the main board.

13. The battery of claim 12, further comprising a support plate arranged adjacent to the main board and supporting the board portion on the main board.

14. The battery of claim 13, further comprising:
a holder; and
a mechanical connection connecting the board portion, the support plate, and the main board to each other and to the holder.

15. The battery of claim 14, further comprising a screw passing through a screw opening of the board portion, a screw opening of the support place, and a screw opening of the main board, and screwed into the holder to define the mechanical connection.

16. The battery of claim 12, wherein:
the cell portion and the cell contact are arranged on a longitudinal side of the battery cell;
the board portion, the main board, and the board contact are arranged on a transverse side of the battery cell extending transverse to the longitudinal side; and
the conductor track further includes a bending portion connecting the cell portion and the board portion, the bending portion arranged in a transition region connecting the longitudinal side and the transverse side.

17. The battery of claim 16, further comprising:
a support plate structured and arranged to support the board portion on the main board;
a holder connected to the board portion, the support plate, and the main board;
wherein a hollow space is defined by and between the main board and the holder; and
wherein the hollow space is laterally open such that a bonding tool for forming the wire-bonds is introducible into the hollow space laterally.

18. The battery of claim 11, further comprising a wire bridge structured as a sheet metal wire, wherein the sheet metal wire is connected to the electrical conductor and the board contact, and defines the wire-bonds.

19. The battery of claim 11, further comprising a plurality of battery cells including the battery cell, wherein:
each of the plurality of battery cells includes a cell contact;
the main board includes a plurality of board contacts including the board contact; and
each of the plurality of board contacts is electrically connected to the cell contact of an associated battery cell of the plurality of battery cells via the conductor track.

20. The battery of claim 19, further comprising a plurality of conductor tracks including the conductor track, wherein:
at least one conductor track of the plurality of conductor tracks includes at least two board portions; and
each board portion of the at least two board portions is connected to the main board via a respective mechanical connection.
